(19) United States
(12) Patent Application Publication
(10) Pub. No.: US 2009/0049742 A1
(43) Pub. Date: Feb. 26, 2009

(54) Reversibly Sealing the Pores of Nets and Its Application to Agricultural Protection

(75) Inventors: Avihai Ilan, Kibbutz Rosh Hanikra (IL); Amir Barnea, Tel Aviv (IL); Jonah Gavrieli, Kiryat Tivon (IL)

Correspondence Address: Avia Kafri, 22Shderot Chen St., Tel Aviv, 64166, IL

(73) Assignee: Ecoseal Ltd, Migdal Haemek (IL)

(21) Appl. No.: 12/223,580

(22) PCT Filed: Feb. 4, 2007
(86) PCT No.: PCT/IL2007/000142

§ 371 Date: Aug. 4, 2008

(30) Foreign Application Priority Data
Feb. 5, 2006 (IL) 173536

(51) Int. Cl. A01G 13/10; C09K 3/10

(52) U.S. Cl. 47/31; 252/182.12

(57) ABSTRACT

The embodiments of the present invention aim to integrate two common agricultural-practices, first of hothouses cover application, and second of protective netting. A method for reversibly sealing the pores of netting by applying a sealing agent on a net in a reversible manner, thereby producing an agricultural covering to protect underlying crops, particularly from cold conditions, is disclosed. A method for reversibly opening the pores of a sealed net, by exposing said portion of the net to chemical or physical unsealing agents and thus opening at least a portion of the sealed pores of the net, is conjointly disclosed. Furthermore, a method of including additives to the sealing agent, which enhances the protective properties of the resultant covering such as its ability to repel insects, its ability to block ultraviolet or other radiation, its water proofing qualities, is also disclosed.

### CROSS-REFERENCE TO RELATED APPLICATIONS

The present application claims the benefit of priority to Israeli Patent Application Serial Number 173536 filed Feb. 5, 2006, titled “METHOD OF REVERSIBLY SEALING THE PORES OF A NETTING AND ITS APPLICATION TO AGRICULTURAL PROTECTION.” The aforementioned application is hereby incorporated herein by reference.

### TECHNICAL FIELD

The present invention generally relates to reversibly sealing the pores of a net and its application to protected cultivation of crops. In particular the present invention relates to a protective covering for crops, which is adapted to suit a variety of diverse environmental and seasonal conditions.

### BACKGROUND OF THE PRESENT INVENTION

The use of protective covering-nets in agriculture is a common practice and is steadily increasing with the growing need to protect crops against harmful insects, animals and weather effects. For example U.S. Pat. No. 5,433,663 describes a fibrous netting, providing proper air ventilation, especially useful for hindering the passage of small insects. This invention provides protection for crops by means of fibrous hairs hindering the passage through the pores of the netting without obstructing airflow. Nets also protect against environmental factors such as strong winds, excess sunlight and to some extent, harsh rainfall and hail.

In regions where winter climatic conditions limit the ability to grow agricultural plants in open-air conditions, glass-houses or plastic covered constructions (“hothouses”) are commonly used. However, conditions in hot houses in the summer are often excessively hot and consequently, in many regions hot-houses are not in use during the summer.

The removal of a protective covering provided by a net and its replacement with a hothouse covering is a costly in terms of time, labor and financial outlay. From economic and environmental-protection perspectives it will be of considerable advantage if a single protective covering could be used in year-round weather conditions. Thus there remains a need for reversibly sealing the pores of netting and its application to protected cultivation crops protection.

### SUMMARY OF THE INVENTION

The main objective of the present invention is to integrate two common agricultural-practices of hothouses and protective netting into a single technology providing for extending the potential cultivation season while saving construction labor and associated costs. In accordance with the present invention the pores of commonly used agricultural nets are temporarily sealed by a sealing agent, comprising a substance or substances that retain intact the protective characteristics of the nets while simultaneously isolate the entities covered by such pore-sealed nets, from harmful insects, animals and adverse ambient conditions. The sealing of pores according to the present invention provides for damping the harmful effects of harsh weather conditions (e.g., low temperatures, wind, rain, hail, snow, as well as UV irradiation) by imposing hothouse growth condition under the net covered structure. Furthermore, the technology provided by the present invention enables a simple and easy removal of the sealing agent at will such as at the end of the cold season, thus restoring the properties of the original net-covering.

It is an objective of the present invention to teach a technique for reversibly sealing at least a portion of the pores of a net by applying a sealing agent onto the net in a reversible manner. An example of the usefulness of the technique is, sealing an agricultural covering net suitable for use under hot conditions into a cover to be also used during cold conditions.

It is another objective of the current invention to teach a technique for opening the pores of at least a portion of such sealed net by exposing said portion of the net to chemical or physical unsealing agent, thus opening at least a portion of the sealed pores of the net, thereby restoring its original covering properties.

It is yet another objective of the present invention to teach technique for sealing at least a portion of the pores of a net by including additives to the sealing agent, which enhance the protective properties of the cover, such as its ability to repel insects, repel animals, an/or to reduce ultraviolet or other radiation, or its water proofing qualities.

It is yet another objective of the present invention to provide a covering device providing for agricultural covering of entities such as articles animals and/or plants, which is made of a common net of which a portion of its pores are reversibly sealed by a sealing agent of the invention.

It is further another objective of the present invention to provide a kit for reversibly sealing a portion of the pores of a net and further removing said sealing agent off said net for restoring the original features of the net.

### DETAILED DESCRIPTION OF THE PRESENT INVENTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a technique for reversibly sealing the pores of a portion of a net and/or reopening the sealed pores of a net and its application to protect entities such as utensils, goods, animals and/or plants.

The term ‘plurality’ applies hereinafter to any integer greater than or equal to one.

The term ‘about’ applies hereinafter to any value in the range from 20% below to 20% above the stated value.

The terms ‘net’ or ‘netting’ apply hereinafter to any discontinuous fabric or other sheet-like member containing pores. Examples of netting include inter alia, warp and weft woven fabric, gauze, mesh, strainer, sieve, leach, sifter, colander; filter, lattice-work, trellis, wicker, cage or any other porous fabric. Said fabric can be formed from any material, such as metal, plastic, polymer, natural or artificial fiber. The weaving of a net refers hereinafter to the fibers skirting or adjacent to the pores of a net.

The term ‘pores’ applies hereinafter to any pores, holes, bores, openings, apertures, spaces or intervals in-between a composition or yarns, providing the netting to be at least partially of discontinuous nature. Said pores are of any shape, or cross section. However their dimensions or sizes are suitable for protecting for example crops and plants against biological and environmental hazards.

The term ‘sealing agent’ applies hereinafter to any material, which seals off the pores of a net of which it has been applied onto and is removably attached to the weaving of the net. Various sealing agents are possible according to the present invention, such as lipids, oils or waxes or any mixtures or combination thereof. More specifically, the netting can be temporarily covered with animal or insect waxes, such as Beeswax—produced by honeybees, Chinese wax—produced by insects Coccus ceriferus, Shellac wax—from lac insect Coccus lacca, Spermaceti—from head cavities and blubber of the Sperm Whale, and/or Lanolin (wool wax)—from the sebaceous glands of sheep. Additionally or alternatively, the wax is of a vegetable source, e.g., Bayberry wax—from the surface of the berries of the bayberry shrub, Candelilla wax—from Mexican shrubs Euphorbia cerifera and E. antisyphilitica, Carnauba wax—the “queen of waxes” from leaves of Carnauba Palm, Castor wax—catalytically hydrogenated castor oil, Esparto wax—a byproduct of making paper from esparto grass, Japan wax—a vegetable tallow (not a true wax), from the berries of Rhus and Toxicodendron species, Jojoba oil—pressed from seeds of the jojoba tree, a replacement for spermaceti, Ouricury wax—from the Brazilian Feather Palm, and/or Rice bran wax—obtained from rice bran. Additionally or alternatively, mineral waxes are used, such as Ceresin waxes, Montan wax—extracted from lignite and brown coal, Ozocerite—found in lignite beds, Peat waxes etc. Petroleum waxes may also be utilized, for example, Paraffin wax—made of long-chain alkane hydrocarbons, Microcrystalline wax—with very fine crystalline structure etc. Synthetic waxes are also applicable, e.g., Polyethylene waxes—based on polyethylene, Fischer-Tropsch waxes, Chemically modified waxes—usually esterified or saponified, substituted amide waxes, and/or polymerized α-olefins.

‘Sealing agent’ as previous defined can also include substances and compounds that are not listed in the above specifications and affect the physical characteristics of the sealing agents. An example of such a substance is the addition of glycerin to ceresin wax or carnauba wax or a mixture of both waxes to enhance the flexibility of the sealing material used.

The term ‘unsealing agent’ applies hereinafter to any factor, which acts so as to degrade, dissolve and/or remove, a film sealing the pores of said netting. Such physical unsealing agents are either ambient factors such as sunlight, particularly its ultraviolet wavelengths, or heat generated by any heat source such as saturated water-steam, or mechanically scrubbing or grinding. Chemical unsealing agents are in accordance with the present invention in a gaseous, liquid, or a solid state. Possible chemical unsealing agents are selected in a non-limiting manner from atmospheric oxygen or ozone that can unseal by destroying specific polymeric bonds, hydrolyzing water, weak acids, such as acetic acid or diluted HCl or H₂SO₄, hypochlorites, such as sodium hypochlorite, caustic soda solutions, water immiscible diluents and wax-diluting solvents, soaps and surfactants, catalytic agents, or any combination thereof.

The term ‘crops’ applies hereinafter to any product, particularly agricultural, which is protected by the covering.

The term ‘cultivation season’ applies hereinafter to the entire duration of time during which a crop is grown.

The terms ‘hothouse’ and or ‘green house’ both apply hereinafter to covering applied to corps and/or plants in the field for protecting against hazards of harsh weather conditions.

According to the present invention, a sealing agent is applied onto a common net by impregnation, brush, spray, aerosol, powder or by any other means, acts so as to seal the pores of the net. For example, the sealing agent can be smeared, coated, impregnated, doped, varnished, brushed or painted, incorporated, bonded, melted, glued, polymerized or otherwise applied onto or incorporated within the pores of the porous net. Controlled release of the sealing agent, which has been previously incorporated within the weaving of the net is further possible according to the present invention, by any commercially available means, such utilizing deactivated means, coated or granulated means, use of liposomes etc.

According to the present invention, at least a portion of the pores of a net is sealed, to enhance the protective properties of a common netting such as its ability to repel insects, its ability to block ultraviolet or other radiation, its water proofing qualities, thereby producing an agricultural covering adapted to protect crops against biological and environmental factors such as protection from hail, snow, sun, ultraviolet rays, wind, birds, mammals, insects, weeds or any other factor harmful to the crops and isolate crops, particularly from cold conditions.

According to some embodiments of the present invention, the sealing agent is applied to the net, for reversibly sealing it, by impregnating the protective netting in the factory or some facility other then a hothouse or greenhouse. After the net has been impregnated with the sealing agent it can be stored, transferred to selling facility and or sold as a finished product to an interested entity. Subsequently, the finished product, reversibly sealed net with the sealing agent whereon, transferred to a greenhouse site and installed. According to these embodiments the preferred technique for applying the sealing agent to the protective netting is impregnation.

According to some other embodiments of the present invention, the sealing agent is applied to the net, for reversibly sealing it, at a greenhouse site prior to, or following, its installation. According to these embodiments the preferred technique for applying the sealing agent to the protective netting is brushing, smearing or spraying.

It is acknowledged in this respect that the netting may be provided and or commercialized in a non-limiting manner in either of the following ways: (a) a ready-made reversibly sealed net impregnated in the factory, before installation in a greenhouse; (b) a kit including a sealing agent and an unsealing agent providing for applying onto a net stretched out in the greenhouse at any time at will.

It is further in accordance with the present invention to apply to at least a portion of reversibly sealed net, which previously was coated or impregnated with a sealing agent, chemical physical or biological unsealing agent, in order to reopen the pores and restoring its net-covering properties, particularly prior to or during hot seasons. According to the present invention, the unsealing agent can be applied onto the sealed net by impregnation brush, spray, aerosol, powder or by any other means, acts so as to dissolve, depolymerize, liquidize or otherwise to decompose the sealing agent and unseal the pores of the sealed netting, without breaching the integrity of the netting. For example, the unsealing agent can be smeared, impregnated, doped, varnished, brushed or painted, incorporated, melted, depolymerized, sprayed or otherwise applied to the sealed netting. Possible physical unsealing agents further include vacuuming or sucking out the sealing agent and can be combined with various chemical or other unsealing agents. Controlled release of a unsealing agent, which was previously incorporated within the netting, is further possible by any commercially available means, such utilizing deactivated means, coated or granulated means, etc.

A reversibly sealed net according to a preferred embodiment of the present invention is made of a common net normally employed for shading and/or protecting crops such as from winds, birds or insects. These nets are typically used for such purposes especially during summer time. A sealing agent consisting of one or a mixture of two kinds of the waxes described inhere above, such as carnauba wax and/or ceresin wax in a predetermined weight ratio are melt and mixed together with a predetermine quantity of a solvent such as turpentine to produce a sealant liquid to be further applied onto the net. Optionally, additives such as zinc powder and or suitable coloring agents, which efficiently absorb and block infrared irradiation, are mixed into the sealant liquid at a predetermined weight ratio. The sealing agent is sprayed or brushed onto the net, which is further left to cure at an ambient temperature of the atmosphere for a predetermined time interval. Such sealed net is suitable for protecting the covered crops from harsh weather conditions during winter. Such sealing is reversible as it can be easily removed at will by applying for example saturated water steam onto the sealed net or by brushing it with a turpentine solution.

For using a reversibly sealed net of the invention for protecting crops against biological and environmental factors, a user either constructs a hothouse utilizing a ready-made reversibly sealed net for its covering, or applies a sealing agent as is described herein above onto a netting stretched out across the field. The user reopens the sealed pores of a reversibly sealed net and restores the covering properties of the original net by applying at will an unsealing agent as described herein above.

It is according to another embodiment of the present invention to produce a reversibly sealed net by mixing additives to the sealing agent, which enhance the protective properties of the covering, such as its ability to repel insects, animals and or birds, its ability to block ultraviolet or other radiation, and/or its water proofing qualities.

It is further noted that it is economically advantageous that such a covering should be reusable for a plurality of seasons extending over a plurality of cultivation seasons, thereby reducing construction costs.

### EXAMPLE 1

According to an exemplary embodiment of the present invention, net-sheets produced by the Meteor Company (Israel) and referred to as “AntiVirus Net” are used; these net-sheets are characterized by: a yarn diameter of 0.24 mm; mesh size of 50×24=20/10; a weight per square meter of 120-140 gram; a transparent color, and shade capacity of about 10%.

The coating solution is prepared by melting carnauba wax powder (Cat. No. 2442 P100 produced by the Kahl Company, Germany) with glycerin (B.P. grade, distributed by the Chen Shmuel Company, Israel) in a boiling water-bath and dissolving the obtained liquid in technical purity grade turpentine (produced by the Colorid Company, Israel) at about 50° C. to form a 4% w/v of the wax and a 0.5% v/v of glycerin. The solution is evenly distributed to form a thin layer on a net-sheet surface by either smearing, brushing or spraying. The solution can be applied at room temperature. Upon evaporation of the turpentine a thin, dry, flexible and opaque hydrophobic layer is formed, sealing the pores of the net.

The wax layer is dissolved and removed at will from the net-sheet by either exposing the layer to a direct stream of saturated water-steam or exposure to turpentine. The coating was found to be weather resistant on exposure of a sheet of 20×20 cm in open-air conditions Mediterranean winter condition ( along December-January).

### EXAMPLE 2

A coating solution is prepared according to a preferred embodiment of the present invention, by melting in a water bath a predetermined amount of carnauba wax powder with a predetermined amount of glycerin to form a turpentine wax solution with a concentration between 2% and 4% and a concentration of between 1% and 0.5% v/v glycerin, as described in example 1 above. The combined concentration of wax and concentration of glycerin determine the thickness and flexibility of the formed layer. The solution of choice is evenly distributed to form a layer having a predefined thickness on a net-sheet surface by either smearing, brushing or spraying. Applying is done at room temperature.

The sealing layer is dissolved and removed at will from the net-sheet by either exposing the layer to a direct stream of saturated water-steam or exposure to turpentine. The combined concentrations of the wax and glycerin determine the flexibility, thickness and durability of the coating film. The coating thickness is inversely proportional to the transparency of the coated net and is proportional to the weather endurance and removal efforts required to remove the coating and reopen the pores of the net.

### EXAMPLE 3

A coating solution is prepared according to another exemplary embodiment of the present invention, by melting a predetermined amount of ceresin wax (Cat. No. 1899 produced by the Kahl Company, Germany) with a predetermined amount of glycerin in a boiling water-bath and dissolving the obtained liquid in technical purity grade turpentine at about 50° C. to form between a 1% and a 10% w/v wax and between 0% and 1% v/v glycerin solution. The solution is evenly distributed to form a thin layer on a net-sheet surface by either smearing, brushing or spraying. Applying is done at room temperature. On evaporation of the turpentine a thin, dry, flexible and opaque hydrophobic layer is formed, sealing the pores of the net. The wax layer is dissolved and removed at will from the net-sheet by either exposing the layer to a direct stream of saturated water-steam or exposure to turpentine. Various concentration combinations of the wax and glycerin enable the determination of the thickness and flexibility of the formed layer.

### EXAMPLE 4

A coating solution is prepared according to another exemplary embodiment of the of the present invention, by melting together predetermined amounts of carnauba wax powder, ceresin wax powder with predetermined amount glycerin in a boiling water-bath and dissolving the obtained liquid in technical grade turpentine at about 50° C. to form a solution having a concentration with ranges of between 2% and 4% w/v carnauba wax, 1% to 10% w/v ceresin wax and between 0% and 1% v/v glycerin. Various combinations of concentration of the waxes and glycerin enable the determination of the thickness and flexibility of the net-coating layer, which can be optimized in accordance to the desired characteristics. The solution is evenly distributed to form a thin layer on a net-sheet surface by either smearing, brushing or spraying. The sealing layer is dissolved and removed at will from the net-sheet by either exposing the layer to a direct stream of saturated water-steam or exposure to turpentine.

It will be appreciated by persons skilled in the art that the present invention is not limited by what has been particularly shown and described herein above and that numerous modifications, all of which fall within the scope of the present invention, exist. Rather the scope of the invention is defined by the claims which follow:

1. A covering device especially suitable for covering crops, said covering device comprising
a net having weaving enclosing pores, wherein the dimensions of said pores provide for protecting said crops against biological and/or environmental factors;
a sealing agent removably attached to the weaving of at least a segment of said net, and
wherein a film of said sealing agent seals off at least a plurality of said pores, and wherein any of said at least plurality of said pores.

2. A covering device as in claim 1, wherein said sealing agent comprises any substance selected from a group of substances consisting of lipids, oils, waxes and any combination thereof.

3. A covering device as in claim 2, wherein said sealing agent further comprises any substance selected from a group of substances consisting of insect repellants, bird repellants, animal repellants and any combination thereof.

4. A covering device as in claim 2, wherein said sealing agent further comprises any additive selected from a group of additives consisting of coloring agents, metallic powders and any combination thereof.

5. A kit for reversibly sealing pores of an agricultural net comprising a sealing agent for applying onto at least a segment of said agricultural net, wherein said sealing agent comprises any substance selected from a group of substances consisting of lipids, oils, waxes and any combination thereof.

6. A kit as in claim 5, further comprising an unsealing agent for removing said sealing agent from said segment of agricultural net.

7. A kit as in claim 5, wherein said sealing agent further comprises any ingredient selected from a group of ingredients consisting of insect repellants, bird repellants, animal repellants and any combination thereof.

8. A kit as in claim 5, wherein said sealing agent further comprises any additive selected from a group of additives consisting of coloring agents, metallic powders and any combination thereof.
